(19) United States
(12) Patent Application Publication
(10) Pub. No.: US 2011/0139079 A1
(43) Pub. Date: Jun. 16, 2011

(54) Livestock nursing nipple

(76) Inventors: Scott Wadsworth, St. Ignatius, MT (US); Jake Wadsworth, St. Ignatius, MT (US)

(21) Appl. No.: 12/653,436

(22) Filed: Dec. 14, 2009

(51) Int. Cl. A01K 9/00

(52) U.S. Cl. 119/71

(57) ABSTRACT

A livestock nursing nipple provides a base portion defining a reservoir neck orifice and having a generally triangular reservoir neck engaging lip, an annular accordion joint structurally interconnects the base portion with an axially extending elongated nipple to absorb deflection forces and deformation forces exerted on the nipple during use, the nipple defining a fluid channel between the base portion and a terminal end defining a fluid outlet.

### BACKGROUND OF THE INVENTION

1. Related Applications

There are no patent applications related hereto previously filed in the United States of America or in any foreign country.

2. Field of Invention

This invention relates to livestock feeding apparatus, and more particularly to a flexible nipple releasably attachable to a reservoir for feeding liquid nourishment therefrom to young animals.

### BACKGROUND AND DESCRIPTION OF PRIOR ART

Calves are often removed from their mothers shortly after birth and are thereafter fed artificially instead of nursing from the mother animal.

Although calves may be taught to drink from a bucket after separation from the mother, aside from the trouble involved in teaching calves to drink from a bucket, many dairymen believe such practice is not conducive to the production of quality veal because drink-fed calves commonly develop a “pot belly” condition which is generally less desirable in the marketplace. For that reason many dairymen feed calves milk, formula or other fluidic nutrition from a reservoir, including but not limited to a bottle-type reservoir, with a nipple attached to a neck end portion of the reservoir about an opening defined therein.

Nutrition reservoirs for nursing calves are known. Such reservoirs define an interior volume and typically have a neck end portion defining an opening communicating with the interior volume through which milk, formula or other fluidic nutrition materials are dispensed from the reservoir. The neck end portion may have an annular radially outwardly extending lip adjacent the opening to enhance attachment of a nipple.

Livestock nursing nipples are also known and generally have an annular base which defines a reservoir neck orifice having a radially inwardly extending lip adjacent the orifice for releasable fluid-tight engagement with a reservoir neck. An elongated cylindrical nipple portion extends axially from the base portion opposite the orifice. The interconnection of the nipple portion to the base portion is typically either a right corner or a rounded corner.

Easy and secure attachment of the nipple to the reservoir is a primary consideration because the pulling and pushing forces a calf may exert on the nipple while suckling may separate the nipple from the reservoir. In practice, the annular base is stretched over and about the reservoir neck. Retentive memory of the material comprising the nipple causes frictional engagement with the bottle neck to retain the milk or fluidic nutrition within the bottle and inside the nipple.

Known livestock nursing nipples continue to have drawbacks and disadvantages because oftentimes the radially inwardly extending lip of the annular base does not completely extend over and about the reservoir neck. If the nipple is not fully engaged with the reservoir neck, the pulling and tugging forces exerted by the calf may cause the nipple pull off the reservoir permitting the contents of the bottle to spill and be wasted. The inwardly extending lip may also cause the base portion to “roll” relative to the reservoir neck when the nipple is installed on the reservoir forming an incomplete seal and allowing leaking therebetween.

Other drawbacks and disadvantages of known livestock nursing nipples include concentrated wear at the corner interconnection of the nipple portion to the base portion; breakage of the nipple portion from the base portion; and inadequate flow of the nutritional formula through the nipple to feed the young animal when the nipple portion is bent by a young animal while suckling.

What is needed is a balance. The interconnection of the nipple to the reservoir must be sufficiently secure to prevent inadvertent disconnection during use; the interconnection must also permit relatively easy intentional disconnection of the nipple from the reservoir for refilling, which may need to occur in less than optimal environmental conditions such as in the cold and in the dark, the nipple should not have a wear spot where deflection forces are concentrated and the nipple must continuously maintain adequate flow of fluidic nutrition to the young animal during suckling.

While this invention has been explained in detail as applied to cattle and animals of the bovine family, is equally applicable to other types of animals which suckle their young, and the form described herein is only for illustration of the more general invention.

For purposes of simplicity and clarity, the term “bottle” is used herein to inclusively describe a variety of reservoir-types including, but not limited to, reservoirs having single and plural openings for dispensing fluidic nutrition to suckling animals as well as manual and automatic animal feeding apparatus having single and plural openings for dispensing fluidic nutrition to suckling animals.

Our invention seeks to overcome the aforementioned and other drawbacks and disadvantages to known livestock nursing nipples by providing an improved livestock nursing nipple having an annular base with radially inwardly extending triangular lip defining a reservoir neck orifice. The triangular lip makes attaching the nipple to the bottle neck easier in difficult environmental conditions by providing a ramp that automatically centers the reservoir neck orifice on the reservoir neck. The triangular lip also prevents “rolling” of the base portion on the reservoir neck which can form an incomplete seal and allow leakage therebetween. An annular bottle engaging groove is defined inside the base portion spaced apart from the triangular lip providing an additional level of fluid-tight engagement with a reservoir neck.

An accordion joint formed of circular concentric folds between the base portion and an axially extending elongated nipple portion enhances the deflection capability of the elongated nipple portion and absorbs axial and angular deflection forces which may collapse and expand at spaced apart portions relative to the elongated nipple. The accordion joint effectively absorbs forces which would otherwise tend to cause the nipple to collapse inwardly upon itself obstructing the flow of fluidic nutrition and the like when the nipple is bent or otherwise deflected and deformed by a suckling young animal. The accordion joint further absorbs forces that might cause the nipple disengage from the reservoir neck.

The elongated nipple portion extends axially from the accordion joint as a cylinder. Distal from the accordion joint the nipple tapers inwardly forming a partial conic to more accurately represent a natural teat of a mother animal. The cylindrical portion of the nipple proximate the accordion joint has an increased wall thickness that in conjunction with the accordion joint prevents the nipple portion from collapsing upon itself when it is deflected by a suckling calf maintaining adequate milk flow to the suckling animal.

A fluid outlet defined in terminal end portion of the elongated nipple, opposite the base, is recessed in a concave depression and is formed by a pair of intersecting through slits.

A recessed vent, that allows air into the reservoir as fluid is removed therefrom by the suckling animal, is positioned at a trough in the accordion joint which causes the vent to open as the elongated nipple portion is deflected by a suckling animal. The position and curvilinear shape of the vent causes the vent to close, when the nipple is not deflected limiting leakage from the nipple.

Our invention does not reside in any single one of the identified features individually but rather in the synergistic combination of all of its structures, which give rise to the functions necessarily flowing therefrom as hereinafter claimed.

### SUMMARY

Our livestock nursing nipple provides a base portion defining a reservoir neck orifice and having a generally triangular reservoir neck engaging lip, an annular accordion joint structurally interconnects the base portion with an axially extending elongated nipple to absorb deflection forces and deformation forces exerted on the nipple during use, the nipple defining a fluid channel between the base portion and a terminal end defining a fluid outlet.

In providing such an apparatus it is:

a principal object to provide such a livestock nursing nipple having an annular accordion joint formed of circular concentric folds between a base portion and an elongated nipple portion that absorbs and distributes forces exerted on the nipple by a suckling animal.

a further object to provide such a livestock nursing nipple having an elongated nipple portion that does not collapse upon itself when deflected by a suckling animal.

a further object to provide such a livestock nursing nipple having an accordion joint that distributes extension and bending stresses to prevent cracking and breaking at the interconnection of the nipple and base.

a further object to provide such a livestock nursing nipple having an accordion joint that absorbs pushing and pulling forces exerted on the nipple by a young animal that instinctively pushes and pulls against its mother to increase milk flow.

a further object to provide such a livestock nursing nipple having a vent that opens when the nipple is deflected equalizing air pressure and allowing fluidic nutrition to flow to a suckling animal.

a further object to provide such a livestock nursing nipple having a vent that closes when the nipple is not deflected to minimize leakage.

a further object to provide such a livestock nursing nipple that will not inadvertently disengage from a reservoir during use.

a further object to provide such a livestock nursing nipple that is easily attachable to a reservoir neck.

a further object to provide such a livestock nursing nipple that forms a reliable fluid tight seal with a reservoir neck.

a further object to provide such a livestock nursing nipple that centers on a reservoir neck for attachment.

a further object to provide such a livestock nursing nipple having a base portion that will not “roll” on the reservoir neck during attachment.

a still further object to provide such a livestock nursing nipple having a tapered elongated nipple to more realistically represent a mother animal's teat.

Other and further objects of our invention will appear from the following specification and accompanying drawings which form a part hereof. In carrying out the objects of our invention it is to be understood that its structures and features are susceptible to change in design and arrangement with only one preferred and practical embodiment of the best known mode being illustrated in the accompanying drawings and specified as is required.

### BRIEF DESCRIPTIONS OF DRAWINGS

In the accompanying drawings which form a part hereof and wherein like numbers refer to similar parts throughout:

FIG. 1 is an orthographic cross-section view of a prior art calf nursing nipple showing the nipple portion collapsing inwardly on the fluid channel responsive to deflection.

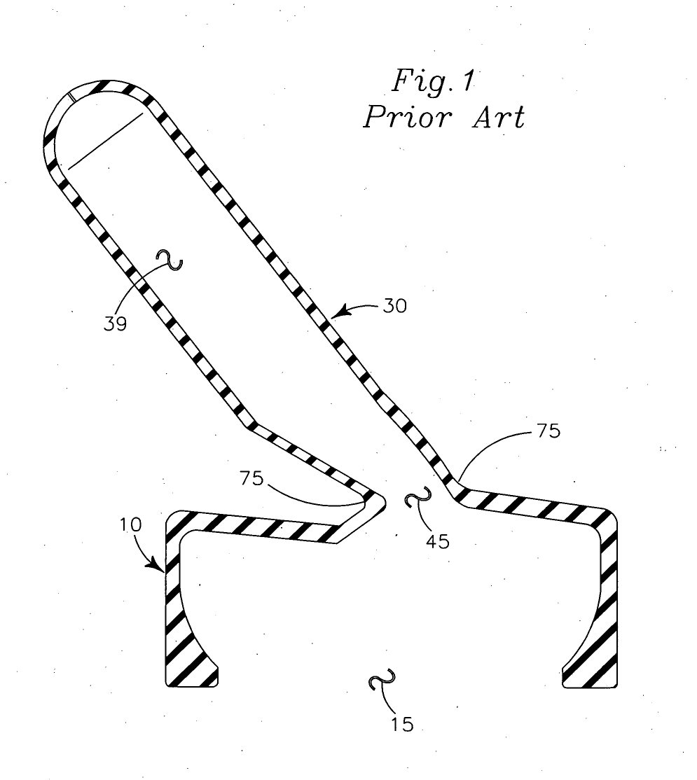

FIG. 2 is an isometric top and side view of our livestock nursing nipple.

FIG. 3 is an orthographic cross-section view of our livestock nursing nipple aligned with and positioned spacedly above an orthographic cross-section view of a neck portion of a bottle-type reservoir.

FIG. 4 is an isometric bottom view of our livestock nursing nipple showing the interior of the nipple.

FIG. 5 is an isometric top and side view of our livestock nursing nipple, similar to that of FIG. 2, showing the elongated nipple portion deflected and the accordion joint collapsing at one side and expanding at the diametrically opposite side.

FIG. 6 is an orthographic partial, cut-away side view of our livestock nursing nipple attached to a bottle-type reservoir with the elongated nipple portion deflected and the accordion joint accommodating the deflection as a calf suckles from the nipple, both the bottle-type reservoir and calf shown in dashed outline.

### DESCRIPTION OF PREFERRED EMBODIMENT

For purposes of simplicity and clarity, the term “bottle” is used herein to inclusively describe a variety of reservoir-types including, but not limited to, reservoirs having single and plural openings for dispensing fluidic nutrition to suckling animals as well as manual and automatic animal feeding apparatus having single and plural openings for dispensing fluidic nutrition to suckling animals.

Our livestock nursing nipple generally provides a resiliently deformable body 9 having base portion 10, a nipple portion 30 and an accordion joint 50 interconnecting the base portion 10 and the nipple portion 30.

The body 9 is formed of known thermal plastics that have the desirable characteristics of being resiliently deformable, strong, flexible, resilient, have retentive memory, not susceptible to cracking and breaking in extreme temperatures, not subject to cracking and breaking when subjected to repetitive stresses nor subject to contamination from bacteria, mold and the like. Further, the material must be suitable for manufacturing processes such as, but not limited to, molding and the like which allows repetitive formation of substantially identical items. It is contemplated however that other non-thermal plastic materials such as, but not limited to, latex and the like that provide the same or similar desirable characteristics may likewise be used to form the body 9.

The base portion 10 is annular having an outer wall 11, an inner wall 12, a bottle engaging end portion 13 and an accordion joint end portion 14. The base portion 10 defines a generally circular bottle neck orifice 15 at the bottle engaging end portion 13. Diameter of the bottle engaging end portion 13 is slightly greater than diameter of the accordion joint end portion 14 forming a slight inward taper toward the nipple portion 30.

Bottle engaging lip 17 is carried by the inner wall 12 of the base portion 10 proximate the bottle engaging end portion 13. The bottle engaging lip 17 is somewhat triangular in configuration having a radially inwardly extending slightly concave bottom surface 18, a radially inwardly extending slightly concave top surface 19, a base portion 20 communicating with the inner wall 12 and a rounded inner terminal edge portion 21 distal from the inner wall 12 that is smaller in cross-section than the base portion 20.

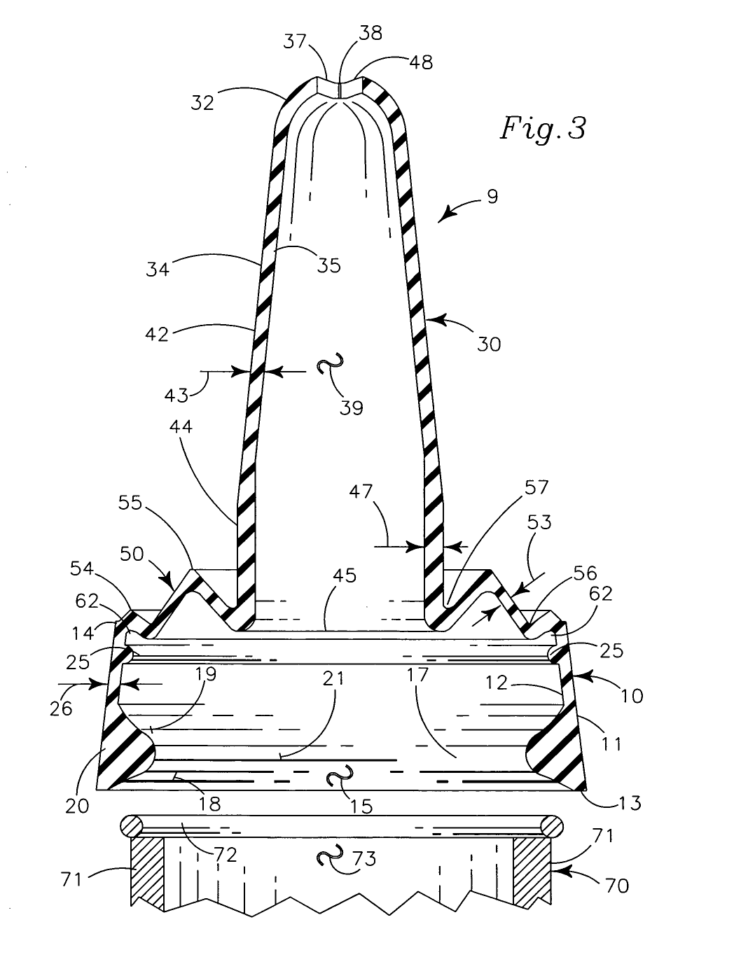

The bottom surface 18 of the bottle engaging lip 17 promotes centering of a bottle neck 71 within the bottle neck orifice 15 and facilitates interconnection of the base portion 10 to the bottle neck 71. As shown in FIG. 3, the bottle neck 71 may carry a bottle neck lip 72 that extends radially outwardly from the bottle neck 71 adjacent bottle opening 73. Configuration of the top surface 19 of the bottle engaging lip 17 facilitates removal of the body 9 from the bottle neck 71 when desired.

As shown in FIG. 3, bottle lip seal 25 is carried by the inner wall 12 of the base portion 10 proximate the accordion joint 50. The bottle lip seal 25 extends radially inwardly from the inner wall 12 creating a recess 62 proximate the intersection of the accordion joint end portion 14, and the accordion joint 50 in which a bottle neck lip 72 may releasably engage.

The accordion joint 50 is annular and is structurally interconnected with the base portion 10 at the accordion joint end portion 14 opposite the bottle neck orifice 15. Best shown in FIG. 3, the accordion joint 50 is formed of circular concentric folds and has a first annular crest 54 proximate the outer wall 11 of the base portion 10. Radially inward from the first crest 54 is an annular first trough 56. Radially inward from the first trough 56 is annular second crest 55. Radially inward from the second crest 55 is annular second trough 57 that is adjacent centered axially extending nipple portion 30.

First trough 56 is located approximately the same vertical distance from the bottle engaging end portion 13 as the interconnection between the accordion joint 50 and base portion 10. Second crest 55 is spaced radially inwardly from the first crest 54 and is larger in size than the first crest 54 which positions the second crest 55 more distal from the bottle engaging end portion 13 than the first crest 54.

Second trough 57 is radially inward of the second crest 55 and is approximately the same vertical distance from the bottle engaging end portion 13 as the first crest 54.

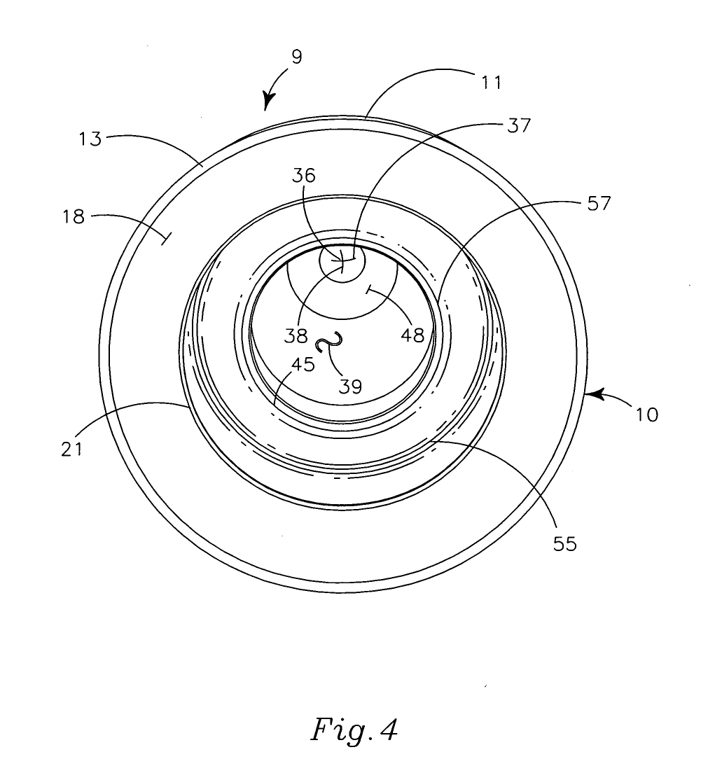

As shown in FIG. 4, the second trough 57 inside base portion 10 defines nipple orifice 45 of the fluid passageway 39.

The nipple portion 30 is elongate and extends axially from center of the accordion joint 50 opposite the bottle engaging end portion 13. The nipple portion 30 has an outer wall 34 and an inner wall 35 with wall thickness 43, 47 therebetween and defines the fluid passageway 39 between the nipple orifice 45 and the rounded terminal end 32. Cylindrical portion 44 of the nipple 30 interconnects with and communicates between the accordion joint 50 and a conic portion 42 of the nipple 30 which is distal from the accordion joint 50 and tapers to a rounded terminal end 32 opposite the base portion 10.

Wall thickness 43 of the conic portion 42 is generally uniform. Wall thickness 47 of the cylindrical portion 44, extending from the accordion joint 50 to the conic portion 42, is preferably greater than wall thickness 43 of the conic portion 42 to prevent collapsing of the nipple 30 during deflection.

Concave depression 48 and fluid outlet 36 are defined in the rounded terminal end 32 of the nipple portion 30. The fluid outlet 36 is preferably formed by a first through slit 37 and an intersecting second through slit 38 forming an X pattern in the center of depression 48. Fluid outlet 36 allows fluidic nutrition such as milk and the like contained within the fluid channel 39 and the bottle 70 to pass therethrough to an animal suckling the nipple 30.

The concave depression 48 tends to inhibit expansion and lengthening of the first slit 36 and second slit 37 over periods of continued use wherein a young animal may “chew” on the nipple portion 30 while suckling. The result is a longer useful life of the livestock nursing nipple.

Accordion joint wall thickness 53 is preferably less than the wall thickness 43, 47 of the nipple portion 30 and wall thickness 26 of the base portion 10. The reduced wall thickness 53 enhances the deflection capability of the nipple portion 30 and reduces the forces exerted on the interconnection of the base portion 10 with a bottle neck 71 when the nipple portion 30 is deflected and deformed by a suckling animal.

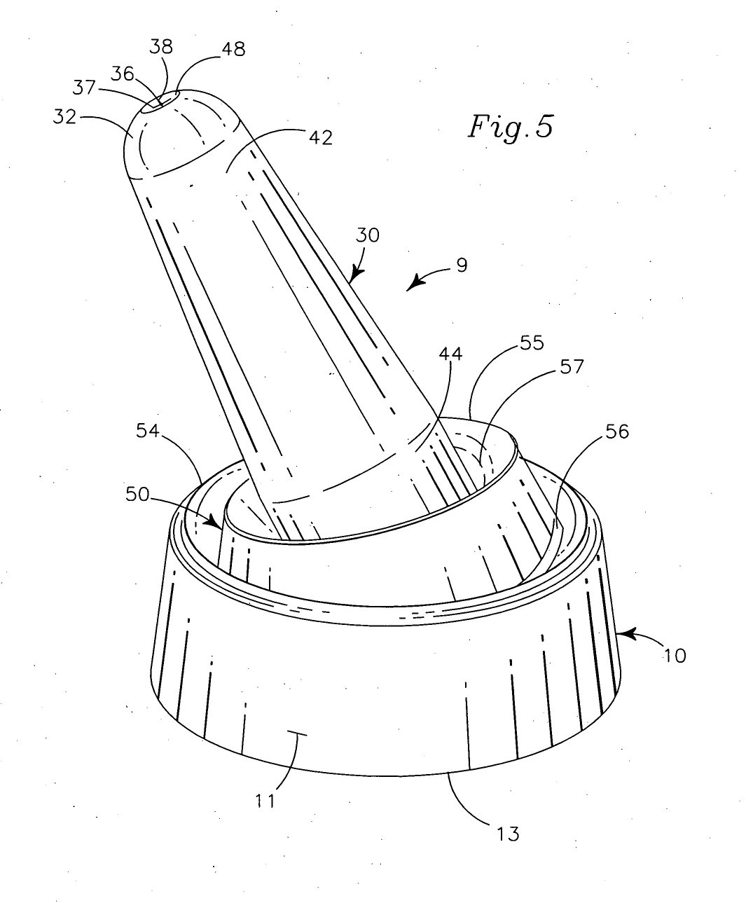

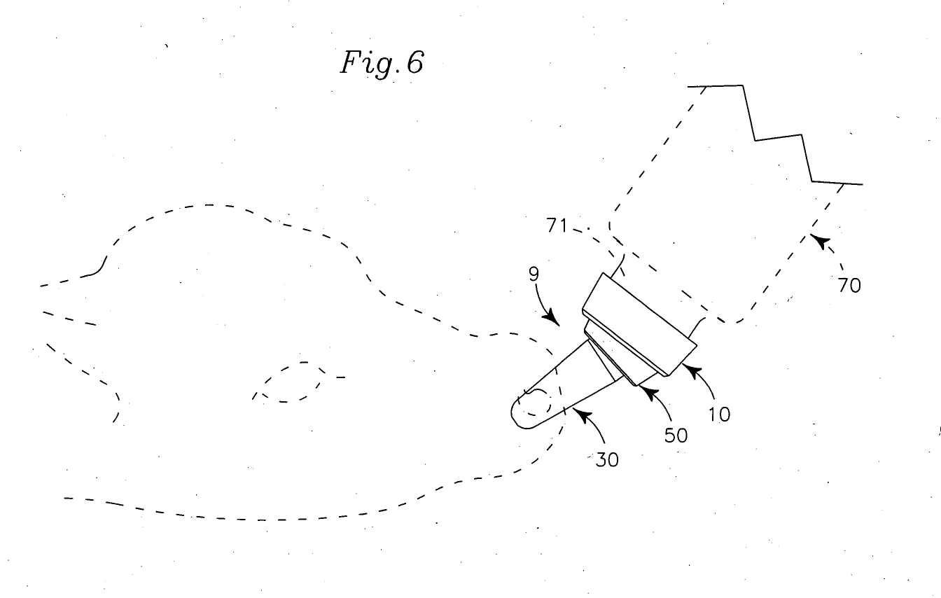

As noted previously, the accordion joint 50 is formed of circular concentric folds and is designed and configured to collapse and compress inwardly and downwardly at one position and simultaneously expand upwardly and outwardly at a spaced apart position when the nipple portion 30 is deflected. This simultaneous expansion and collapsing of the accordion joint 50 is best shown in FIG. 5 and FIG. 6. The reduction of forces exerted on the interconnection of the base portion 10 and the bottle 70 also reduces the likelihood that the body 9 will detach from the bottle 70 inadvertently during use. Finally, the flexibility of the accordion joint 50 reduces the likelihood that the nipple portion 30 will collapse inwardly upon itself when it is deflected obstructing the fluid passageway 39 and preventing passage of nutrients to the suckling animal. (FIG. 7).

The accordion joint 50 further extends the useful life of the nipple, by preventing bending, tension, compression and shearing forces from being concentrated at a single right or rounded corner joint 75 (FIG. 7) where the nipple portion 30 interconnects to the base portion 10. The distribution of these forces across a wider area prevents the formation of cracks that develop over time with continued use, and especially in extreme weather conditions.

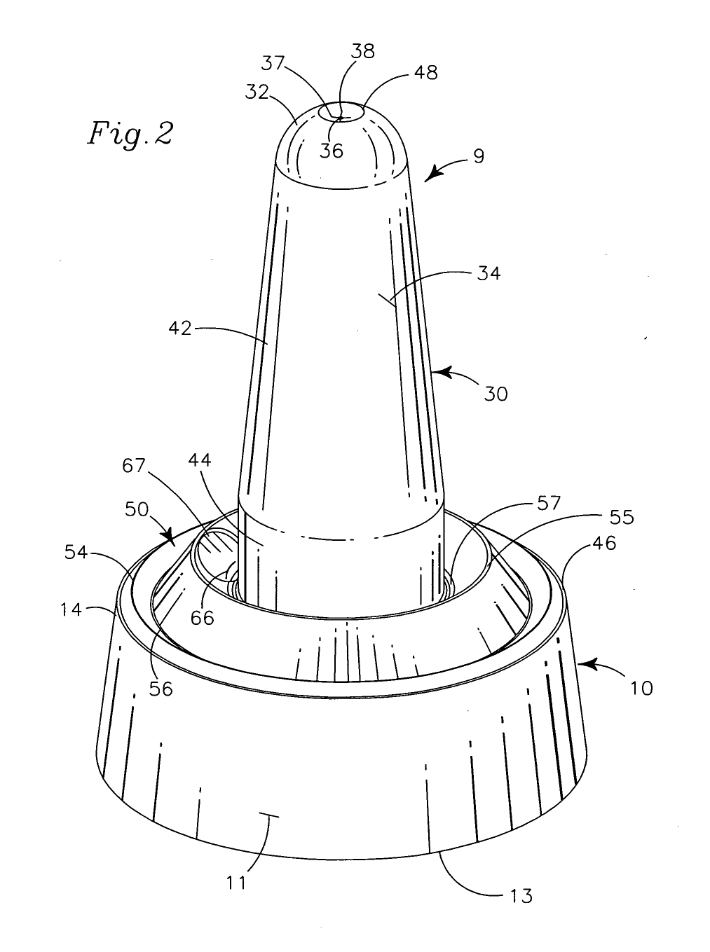

As shown in FIG. 2, vent 66 is a through slit defined in the accordion joint 50 preferably at a position proximate the second trough 57 and within a depression 67 formed in the accordion joint 50. The position of the vent 66 in the depression 67 inside the accordion joint 50 causes the vent 66 to tend to open responsive to deflection of the nipple portion 30 which allows equalization of air pressure inside the bottle 70 so that fluidic nutrition can flow to the suckling animal through fluid outlet 36. Likewise, when the nipple portion 30 is not deflected, the vent 66 tends to close reducing the leakage of any fluidic nourishment from the fluid outlet 36 which would be wasted.

In the preferred embodiment, the vent 66 is configured similar to the curvature of the proximate second trough 57 and has an arcuate shape. However, configuration of the vent 66 may be otherwise such as a radially aligned through slit which has been found to function nearly as efficiently as an arcuate through slit.

Having described the structure of our livestock nursing nipple, its operation may be understood.

Fluidic nourishment, in the form of milk, nutritional supplement, or otherwise appropriate for the young animal is added to a bottle 70 through a bottle opening 73 defined in the neck portion 71 of the bottle 70, so that the fluidic nourishment is contained within the bottle 70.

The body 9 is oriented so that the base portion 10 defining the bottle neck orifice 15 is positioned over and adjacent the neck 71 of the bottle 70. Body 9 is moved axially relative to the neck portion 71 of the bottle 70. Exertion of pressure on the base portion 10 causes the neck portion 71 of the bottle 70 to automatically center relative to the bottle neck orifice 15 defined by the bottle engaging end portion 13 of the base portion 10. The bottom surface 18 of the bottle engaging lip 17 acts as a ramp causing the base portion 10 to expand radially outwardly over the neck portion 71 of the bottle 70. If the bottle 70 has a radially outwardly extending a lip 72 adjacent the bottle opening 73, the bottle engaging lip 17 expands radially thereover so that the radially extending lip 72 of the bottle 70 passes inwardly over the bottle engaging lip 17 of the base portion 10.

The user should continue to exert axial pressure on the base portion 10 so that the radially extending lip 72 of the bottle 70 passes over the bottle lip seal 25 and frictionally engages with the bottle lip recess 62 inside the base portion 10. The retentive memory of the material forming the body 9 responsively contracts about the neck portion 71 forming fluid tight seal about a neck portion 71 of the bottle 70.

Bottom and top surfaces 18, 19 of the bottle engaging lip 17 and a diametrically larger base portion 20 of the bottle engaging lip 17, as compared to the inner rounded terminal edge 21 of the lip 17 prevent the bottle engaging lip 17 from “rolling” along the neck portion 71 of the bottle 70. As a result, the rounded terminal edge 21 of the bottle engaging lip 17 slides along the bottle neck 71 maintaining a fluid tight seal therebetween.

Once the body 9 is affixed to the bottle 70 containing the fluidic nourishment, the bottle 70 may be inverted or otherwise manipulated as desired by a user and a young animal allowed to suckle from the nipple portion 30. As a young animal suckles from the nipple 30, the natural tendency of young animals is to push, pull, twist, and otherwise “chew-on” and deflect and deform the nipple portion 30 in efforts to maximize the outflow of the fluidic nourishment through the fluid outlet 36. Responsive to the pushing, pulling, tugging, twisting and chewing of the young animal on the nipple portion 30, the vent 66 opens to equalize the air pressure within the bottle 70 with the atmosphere. Equalization of the air pressure maximizes the flow of fluidic nourishment through the fluid outlet 36. Chewing action by a young animal, if any, may further enhance fluidic nourishment flow by opening the first slit 37 and second slit 38.

The accordion joint 50 absorbs and redistributes the various physical forces including, but not limited to, tensive forces, extensive forces, crushing forces and shearing forces exerted on the nipple 30 by the young animal while suckling. The collapsing and expansion of the accordion joint 50 dissipates such forces and prevents such forces from being concentrated at to the interconnection of the bottle engaging lip 17 and the bottle neck 71. The accordion joint 50 enhances the ability of the body 9 to remain in a fluid tight engagement with the bottle neck 71 whereas prior-art livestock nursing nipples would periodically disengage from the bottle neck 71 as a result of such forces.

When the young animal has consumed the fluidic nourishment within the bottle 70, a user may grasp the base portion 10 about the outer wall 12, and by pulling the body 9 axially away from the bottle 70, the neck portion 71 of the bottle 70 may be withdrawn from the bottle neck orifice 15. Detachment allows the bottle 70 to be refilled and allows for the bottle 70 and body 9 to be cleaned as necessary.

The foregoing description of our invention is necessarily of a detailed nature so that a specific embodiment of a best mode may be set forth as is required, but it is to be understood that various modifications of details, and rearrangement, substitution and multiplication of parts may be resorted to without departing from its spirit, essence or scope.

Having thusly described our invention, what we desire to protect by Letters Patent, and

What we claim is:

1. A livestock nursing nipple releasably attachable to a reservoir for dispensing fluidic nourishment therefrom to a suckling animal, the livestock nursing nipple comprising in combination:
a base portion having a reservoir engaging end portion and an opposing accordion joint end portion, the reservoir engaging end portion defining a reservoir neck orifice for releasable engagement about an opening defined in the reservoir neck;
an accordion joint carried by the base portion at the accordion joint end portion communicating with a centered elongate nipple portion that extends axially from the accordion joint opposite the reservoir neck orifice;
a fluid passageway defined by the elongate nipple portion communicating from the base portion to a rounded terminal end portion distal from the base portion; and
a deformable fluid outlet defined in the terminal end portion of the elongate nipple portion communicating with the fluid passageway to allow fluidic nourishment to pass therethrough upon deformation to the suckling animal.

2. The livestock nursing nipple of claim 1 further comprising:
a reservoir neck engaging lip carried on inner wall inside the base portion proximate the reservoir engaging end portion, the reservoir neck engaging lip defining the reservoir neck orifice and having,
a radially inwardly and upwardly extending first surface,
a radially inwardly and downwardly extending second opposing surface, and
an inner edge portion communicating between the first surface and the second surface proximate center of the reservoir neck orifice.

3. The livestock nursing nipple of claim 1 further comprising:
a depression defined in the accordion joint; and
a through slit defined in the depression forming a vent to equalize air pressure inside the livestock nursing nipple with external air pressure.

4. The livestock nursing nipple of claim 3 wherein:
the depression is defined in the accordion joint at a trough in the accordion joint; and
the through slit is curvilinear and is defined proximate the trough.

5. The livestock nursing nipple of claim 1 further comprising:
a concave depression defined in the terminal end portion of the elongate nipple portion; and
two intersecting through slits defined in the concave depression are releasably deformable to allow fluidic nourishment to pass therethrough upon deformation to the suckling animal.

6. The livestock nursing nipple of claim 1 wherein:
the elongated nipple portion is cylindrical adjacent the accordion joint and is conic distal from the accordion joint.

7. The livestock nursing nipple of claim 1 wherein:
the accordion joint has circular concentric folds.

8. The livestock nursing nipple of claim 1 wherein:
the accordion joint has plural radially spaced circular concentric folds, each circular concentric fold having a trough and a crest
